(19) United States
(12) Patent Application Publication
(10) Pub. No.: US 2026/0170151 A1
(43) Pub. Date: Jun. 18, 2026

(54) FEATURE EXTRACTION DEVICE AND FEATURE EXTRACTION METHOD FOR IDENTIFYING VULNERABILITIES IN BINARY CODE

(71) Applicant: KOREA UNIVERSITY RESEARCH AND BUSINESS FOUNDATION, Seoul (KR)

(72) Inventors: Sang Kyun LEE, Hanam-si (KR); Jung Hwan PARK, Seoul (KR); Seong Hyun PARK, Seoul (KR)

(21) Appl. No.: 19/417,225

(22) Filed: Dec. 11, 2025

(30) Foreign Application Priority Data
Dec. 16, 2024 (KR) 10-2024-0187592
May 15, 2025 (KR) 10-2025-0063493

(51) Int. Cl. G06F 21/57

(52) U.S. Cl. CPC G06F 21/577; G06F 2221/033

(57) ABSTRACT

The present disclosure relates to a feature extraction device for identifying vulnerabilities in binary code, including a binary segmentation circuitry for dividing the binary code into function units, a control flow graph (CFG) extraction circuitry for extracting a CFG feature representing control flow in the function units, a data flow graph (DFG) extraction circuitry for extracting a DFG feature representing value flow in the function units, and a PDG synthesis circuitry for decomposing the CFG feature and synthesizing the DFG feature with the decomposed CFG feature to generate a program dependence graph (PDG) expressing control and data dependencies. By doing so, the device analyzes the value flow, selectively extracts value flows meaningful for vulnerability analysis, generates a PDG integrated with the CFG, and provides feature information required for a vulnerability analysis model. As a result, feature information may be obtained through static analysis without requiring separate source code.

### CROSS REFERENCE TO RELATED APPLICATIONS

This application claims priority to Korean Patent Application No. 10-2024-0187592, filed on Dec. 16, 2024, and Korean Patent Application No. 10-2025-0063493, filed on May 15, 2025, in the Korean Intellectual Property Office, which are incorporated by reference herein in their entirety.

### TECHNICAL FIELD

The present disclosure relates to a feature extraction device and a feature extraction method for identifying a vulnerability in a binary code, and more specifically, to a feature extraction device and a feature extraction method for identifying a vulnerability in a binary code capable of acquiring feature information for vulnerability analysis.

### BACKGROUND

Recently, due to the development of Internet technology, the dependence on the Internet is increasing in society as a whole. This has also caused an increase in software released and sold. Unfortunately, this has also caused an increase in cyber-attacks. As a result, an overall range of damage that cyber-attacks can infringe on and the attack surface on which cyber-attacks can be performed continue to expand.

Methods of analyzing a conventional software security vulnerability prepared to prevent such a cyber-attack include a source code-based coding rule inspection method, a control flow graph inspection method through static analysis, and the like.

The source code-based coding rule inspection method includes securing the source code of the target software and detecting security vulnerabilities existing in the source code through a source code-based vulnerability inspection tool such as detecting a predefined vulnerability pattern. However, since most of the commercial software may not secure the configuration source code, the source code is reversed using a binary reversing tool such as an interactive disassembler (IDA) pro, and then the vulnerability is checked in the source code.

Meanwhile, the control flow graph extracted through a method of extracting a control flow graph explaining the operation of a binary through static analysis is mainly used for data of artificial intelligence-based vulnerability analysis technology.

However, since each node of the control flow graph has a form in which several assembly instructions are mixed, information of each node is complicated, and it is difficult to meaningfully express information.

In addition, there is a problem in that an accurate vulnerability analysis cannot be performed because the range of variables involved in the occurrence of an actual vulnerability, which is expressed as a value flow, cannot be predicted only from the control flow, and an excessive number of false positives (for example, when the code that is not actually vulnerable is determined to be vulnerable) is generated due to simplified data, thereby reducing the efficiency of the analysis.

Therefore, in order to improve the performance of the vulnerability analysis model, it is necessary to analyze not only the control flow but also the value flow in the absence of the source code and integrate it so that it may be input into the vulnerability analysis model.

### SUMMARY

The present disclosure has been made in an effort to solve the above-described technical problems, and an object of the present disclosure is to provide a feature extraction device and a feature extraction method for identifying a vulnerability in a binary code, wherein the feature extraction device and the feature extraction method are capable of analyzing a value flow in order to improve limitations of binary static analysis, selectively extracting a value flow significant for vulnerability analysis and generating the program dependence graph (PDG) integrated with a control flow graph (CFG) to extract and provide feature information required for a vulnerability analysis model, and extracting only feature information through static analysis without a separate source code.

In addition, an object of the present disclosure is to provide a feature extraction device and a feature extraction method for identifying a vulnerability in a binary code, capable of improving the efficiency of a vulnerability analysis process by providing feature information including analyzed value flow information to reduce false positives of static vulnerability analysis of binary code software using only a conventional CFG, thereby reducing a group of vulnerability candidates to be finally identified.

In addition, an object of the present disclosure is to provide a feature extraction device and a feature extraction method for identifying a vulnerability in a binary code, which can be easily expanded for various platforms by analyzing the PDG analyzed on a source code based on an intermediate expression as well as being able to be extracted in a form that is easy to analyze a vulnerability for a binary code.

According to an aspect of the present disclosure, there is provided a device for extracting a feature for identifying a vulnerability in a binary code, the device including binary segmentation circuitry configured to segment the binary code into function units, control flow graph (CFG) extraction circuitry configured to extract a CFG feature, which is a control flow in function units, from the segmented binary code, data flow graph (DFG) extraction circuitry configured to extract a DFG feature, which is a flow of values in function units, from the segmented binary code, PDG synthesis circuitry configured to decompose the CFG feature, and synthesize the DFG feature with the decomposed CFG feature to generate a program dependence graph (PDG) representing control and data dependencies.

The CFG extraction circuitry may include: a CFG generation circuitry configured to analyze a control flow in a function unit from the segmented binary code to generate a CFG representing the control flow as node and edges; and a CFG inspection circuitry configured to search for a control flow calling an external library from the generated CFG to extract the CFG feature by modifying at least one of a node and an edge required for identifying a vulnerability.

In addition, the CFG inspection circuitry may search up to a basic block returned according to a function call corresponding to a control flow calling the external library, delete an edge representing the control flow calling the external library according to the search result, and add an edge connected to the basic block.

The DFG extraction circuitry may include: a DFG generation circuitry configured to generate a DFG representing a propagation flow of actual values as nodes and edges through a search of a process of storing, reading, or writing the actual value of the segmented binary code; and a DFG inspection circuitry configured to search for edges based on all values of the binary code in the generated DFG, and extract the DFG feature by correcting edges related to a variable.

The DFG inspection circuitry may separate an area of a memory in which the variable is stored for each variable, identify a type of the variable, select only the types of variables necessary for the vulnerability type, and maintain only an edge of the memory corresponding to the selected variable.

In addition, the PDG synthesis circuitry decomposes the node of the CFG feature and synthesizes the edge of the DFG feature with the decomposed node to generate the PDG, wherein the basic unit of the decomposed node may be a raw code.

According to another aspect of the present disclosure, there is provided a feature extraction method in a feature extraction device for identifying a vulnerability in a binary code, the feature extraction method including: dividing the binary code into function units; extracting a control flow graph (CFG) feature, which is a control flow in the function unit, from the segmented binary code; extracting a data flow graph (DFG) feature, which is a flow of values in the function unit, from the segmented binary code; and decomposing the CFG feature and synthesizing the DFG feature with the decomposed CFG feature to generate a program dependence graph (PDG) representing control and data dependencies.

The extracting of the CFG feature may include generating a CFG representing the control flow as nodes and edges by analyzing the control flow in a function unit from the segmented binary code, and extracting the CFG feature by searching the generated CFG for a control flow calling an external library and modifying at least one of the node and the edge required for identifying the vulnerability.

The extracting of the DFG feature may include generating a DFG representing a propagation flow of actual values as nodes and edges through a search of a process of storing, reading, or writing the actual value of the segmented binary code, and extracting the DFG feature by searching for an edge based on all values of the binary code in the generated DFG and correcting edges related to a variable.

The generating of the PDG may include decomposing a node of the CFG feature and generating the PDG by synthesizing an edge of the DFG feature with the decomposed node, wherein a basic unit of the decomposed node may be a raw code.

According to one aspect of the present disclosure, provided are a feature extraction device and a feature extraction method for identifying a vulnerability in a binary code, thereby analyzing a value flow in order to overcome the limitations of binary static analysis, selectively extracting a value flow meaningful for the analysis of a vulnerability to generate a PDG integrated with the CFG, extracting and providing feature information required for a vulnerability analysis model, and extracting only feature information through static analysis without a separate source code.

In addition, by providing a feature extraction device and a feature extraction method for identifying a vulnerability in a binary code, it is possible to improve the efficiency of a vulnerability analysis process by providing feature information including analyzed value flow information to reduce false positives of static vulnerability analysis in binary code software using only a conventional CFG, thereby reducing a group of vulnerability candidates to be finally identified.

In particular, by providing a feature extraction device and a feature extraction method for identifying a vulnerability in a binary code according to the present embodiment, it is possible to extract the PDG, which is generally analyzed on a source code, in a form that is easy to analyze the vulnerability in the binary code, and it is also possible to easily expand the method for various platforms by analyzing it based on an intermediate expression.

### BRIEF DESCRIPTION OF THE DRAWINGS

FIG. 1 is a block diagram for describing a feature extraction device according to an embodiment of the present disclosure,

FIG. 2 is a diagram for describing CFG features generated by a feature extraction device according to an embodiment of the present disclosure,

FIG. 3 is a diagram for describing DFG features generated by a feature extraction device according to an embodiment of the present disclosure,

FIG. 4 is a diagram for describing a PDG generated by a feature extraction device according to an embodiment of the present disclosure, and

FIG. 5 is a flowchart for describing a feature extraction method according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

A detailed description of the present disclosure, which will be described later, refers to the accompanying drawings, which illustrate specific embodiments in which the present disclosure may be practiced as examples. These examples are described in detail to be sufficient for those skilled in the art to practice the present disclosure. It should be understood that the various embodiments of the present disclosure are different from each other but need not be mutually exclusive. For example, certain shapes, structures, and characteristics described herein may be implemented in other embodiments without departing from the spirit and scope of the present disclosure in connection with one embodiment. It should also be understood that the position or arrangement of individual components within each disclosed embodiment may be altered without departing from the spirit and scope of the present disclosure. Accordingly, the detailed description to be described below is not intended to be taken in a limited sense, and the scope of the present disclosure, if properly described, is limited only by the appended claims along with all the scope equivalent to those claimed by the claims. Similar reference numerals in the drawings refer to the same or similar functions across several aspects.

The components according to the present disclosure are components defined by functional classification rather than physical classification, and may be defined by functions performed by each. Each component may be implemented as hardware or a program code and a processing unit that perform each function, and functions of two or more components may be included in one component to be implemented. Accordingly, it should be noted that the names given to the components in the following embodiments are not intended to physically distinguish each component, but are given to imply a representative function in which each component is performed, and the technical spirit of the present disclosure is not limited by the names of the components.

In the entire specification, when a part is described as being “connected” (attached, contacted, coupled) to another part, it includes not only being “directly connected” but also “indirectly connected” through another component. Also, when a part is described as “including” a component, it means that it may further include other components, unless otherwise specified.

The terminology used in this specification is intended only to describe specific embodiments and is not intended to limit the present invention. The singular expressions may include plural expressions unless the context clearly indicates otherwise. In this specification, terms such as “comprise” or “have” are intended to indicate the presence of the stated features, numbers, steps, operations, elements, components, or combinations thereof, and are not intended to exclude the possibility of the presence or addition of one or more other features, numbers, steps, operations, components, or combinations thereof.

In this specification, the term “module” includes a unit configured in hardware, software, or firmware, and may be used interchangeably with terms such as logic, logic block, component, circuit, or circuitry. A module may be an integrated component or the smallest unit performing one or more functions, or a part thereof. For example, the module may be implemented as an application-specific integrated circuit (ASIC).

Hereinafter, exemplary embodiments of the present disclosure will be described in more detail with reference to the drawings.

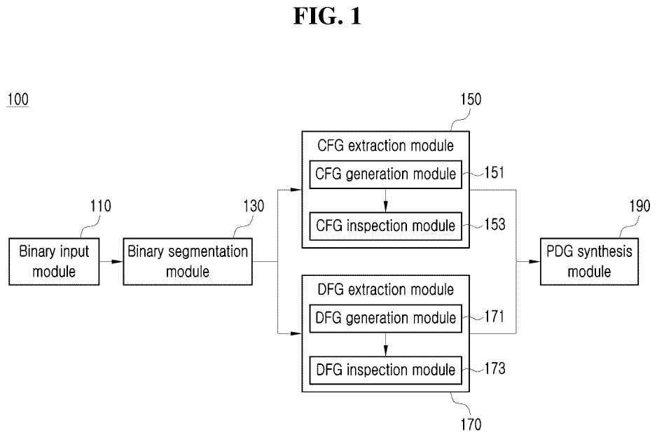

FIG. 1 is a block diagram for explaining a feature extraction device 100 according to an embodiment of the present disclosure.

The feature extraction device 100 according to the present embodiment is provided to extract feature information necessary for vulnerability analysis by statically analyzing a binary code as data used in an artificial intelligence-based vulnerability analysis model by analyzing the binary code in an intermediate representation.

To this end, the device 100 according to the present embodiment includes a binary input module 110, a binary segmentation module 130, a control flow graph (CFG) extraction module 150, a data flow graph (DFG) extraction module 170, and a program dependence graph (PDG) synthesis module 190.

In the device 100, software (application) for performing the feature extraction method may be installed and executed, and the binary input module 110, the binary segmentation module 130, the CFG extraction module 150, the DFG extraction module 170, and the PDG synthesis module 190 may be controlled by software (application) for performing the feature extraction method.

In this case, the device 100 may be a separate terminal or some module of the terminal. In addition, the binary input module 110, the binary segmentation module 130, the CFG extraction module 150, the DFG extraction module 170, and the PDG synthesis module 190 may be configured as an integrated module or may be configured as one or more modules. However, on the contrary, each configuration may be formed as a separate module.

In addition, the device 100 may have mobility or may be fixed. The device 100 may be in the form of a server or an engine, and may be referred to as other terms such as a device, an apparatus, a terminal, a user equipment (UE), a mobile station (MS), a wireless device, and a handheld device. The device 100 may execute or develop various software based on an OS (Operating System), that is, a system. Here, the operating system is a system program for enabling software to use hardware of a device, and may include all of mobile computer operating systems such as Android OS, iOS, Windows mobile OS, Bada OS, Symbian OS, and BlackBerry OS, and computer operating systems such as Windows, Linux, Unix, MAC, AIX, and HP-UX.

Although not shown in the drawings, the device 100 may further include a storage unit. The storage unit records a program for performing the feature extraction method. In addition, the storage unit temporarily or permanently stores data processed by the binary input module 110, the binary segmentation module 130, the CFG extraction module 150, the DFG extraction module 170, and the PDG synthesis module 190, and may include a volatile storage medium or a non-volatile storage medium, but the scope of the present disclosure is not limited thereto. In addition, the storage unit stores data accumulated while performing the feature extraction method.

First, the binary input module 110 according to the present embodiment is provided to receive information that enables actual access to the binary, such as a path of the binary, from the user.

Accordingly, the binary input module 110 may collect the binary according to the access information provided by the user and transmit the collected binary to the binary segmentation module 130.

More specifically, the binary input module 110 may receive a binary code file in a system or a binary code file in an accessible format by being uploaded to a file server or the like by a user.

Meanwhile, the binary segmentation module 130 may divide the binary code received from the binary input module 110 into function units.

Specifically, the binary segmentation module 130 may be a program module that performs a preparation process for analyzing a binary code, and may analyze a function signature in the binary code by scanning a target binary code file. In addition, the binary segmentation module 130 may analyze a binary code signature such as 32-64-bit information or an architecture.

In this case, the binary segmentation module 130 may allow the user to set an analysis range, an analysis method, and the like before analyzing the signature.

In addition, the binary segmentation module 130 may divide the binary code to be analyzed by the CFG extraction module 150 and the DFG extraction module 170 into function units for the calculation efficiency of the CFG extraction module 150 and the DFG extraction module 170, and may transmit the result of the segmentation to the CFG extraction module 150 and the DFG extraction module 170.

Meanwhile, the CFG extraction module 150 according to the present embodiment is provided to extract a control flow graph (CFG) feature, which is a control flow in a function unit, from the segmented binary code.

In one embodiment, the CFG extraction module 150 includes a CFG generation module 151 and a CFG inspection module 153. In one embodiment, the DFG extraction module 170 includes a DFG generation module 171 and a DFG inspection module 173. In some embodiments, the CFG extraction module 150 can be referred to as CFG extraction circuitry, the CFG generation module 151 can be referred to as CFG generation circuitry, the CFG inspection module 153 can be referred to as CFG inspection circuitry, the DFG extraction module 170 can be referred to as DFG extraction circuitry, the DFG generation module 171 can be referred to as DFG generation circuitry, and DFG inspection module 173 can be referred to as DFG inspection circuitry.

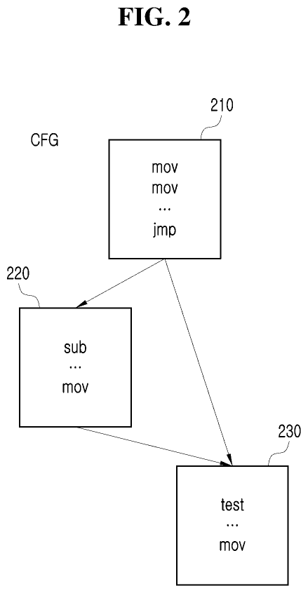

FIG. 2 is a diagram for describing a CFG feature generated by the CFG extraction module 150 according to an embodiment of the present disclosure.

The CFG features extracted through the CFG extraction module 150 may be converted into a JavaScript Objection Notation (JSON) formatted text file to effectively store the graph form and use it for vulnerability analysis. Also, in general, each node of the CFG may be composed of a set of assembly instructions, referred to as a basic block as shown in FIG. 2.

To extract such CFG features, the CFG extraction module 150 may include a CFG generation module 151 and a CFG inspection module 153 as described with reference to FIG. 1.

First, the CFG generation module 151 according to the present embodiment may generate a CFG representing the control flow as nodes and edges by analyzing the control flow in a function unit from the segmented binary code.

That is, the CFG generation module 151 according to the present embodiment may read binary code information segmented into function units from the segmented binary code and analyze the CFG at the function-unit level, and the CFG analyzed in function units may be connected and integrated through call flows that is a part of a control flow.

In addition, the CFG generation module 151 may transmit the generated CFG to the CFG inspection module 153.

Meanwhile, the CFG inspection module 153 according to the present embodiment may search for a control flow calling an external library in the generated CFG, and may extract the CFG feature by modifying at least one of a node and an edge required for identifying a vulnerability.

Through this, the CFG inspection module 153 according to the present embodiment may search for an internal call relationship restoration flow to enable analysis of the execution flow of the actual binary, as well as enable analysis of meaningful vulnerabilities for the entire binary.

Specifically, the CFG generated and integrated in a function unit through the CFG generation module 151 may be a part related to a function call, for example, in which several noise elements remain.

In general, when an external library function is called when writing source code, most of them are dynamically connected within a binary. This does not exist in the actual binary code, but exists as a separate library function, and requires a process of finding and calling the library function when executed. To this end, the binary code of the Linux environment may use a Global Offset Table (GOT) and a Procedure Linkage Table (PLT). Therefore, the binary code includes this process, which is included in the CFG, which is an output generated from the CFG generation module 151, but may be noise that acts as an unnecessary element in the process of identifying the actual vulnerability path.

Accordingly, the CFG inspection module 153 according to the present embodiment may be provided to remove the external library call flow acting as such an unnecessary element to retain only information meaningful for the vulnerability path.

Specifically, the CFG inspection module 153 according to the present embodiment may first define the source code of external libraries frequently used in writing a source code in advance, and define an external library function among functions existing in a binary code.

In addition, the CFG inspection module 153 may find a control flow that calls a defined external library among all control flows, and may search for the basic block reached after returning from the corresponding function call according to the function call after the function call.

In addition, the CFG inspection module 153 may delete the edge representing the external-library call flow according to the search result after performing a search to the basic block but may add an edge connected to the returned basic block.

The CFG extraction module 150 including the above-described CFG generation module 151 and CFG inspection module 153 may extract CFG features by performing integration while leaving only nodes and edges necessary for vulnerability analysis in the CFG. The CFG extraction module 150 may transmit the extracted CFG feature to the PDG synthesis module 190.

Meanwhile, the DFG extraction module 170 according to the present embodiment is provided to extract a data flow graph (DFG) feature, which is a flow of values in a function unit, from the segmented binary code.

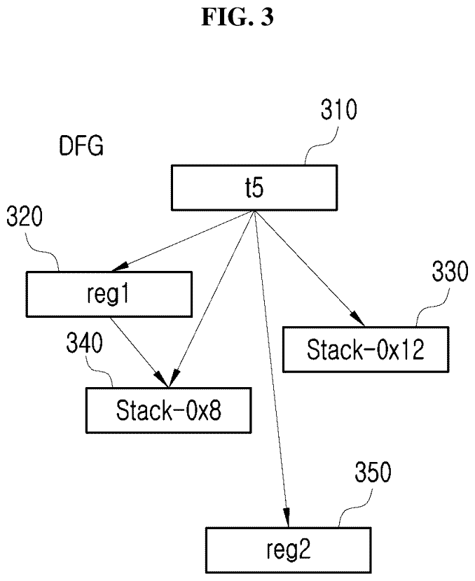

FIG. 3 is a diagram for describing a DFG feature generated by the DFG extraction module 170 according to an embodiment of the present disclosure.

The DFG feature extracted through the DFG extraction module 170 is a result of analyzing the flow of values in the function unit area of the segmented binary code in a graph form, and specifically, the propagation flow of actual values inside the binary code is extracted based on the intermediate representation language. In addition, each node of the DFG may be composed of an instruction of an intermediate representation language or a variable in an expression. More preferably, the DFG extraction module 170 may use only the variable of the expression as each node of the DFG, but is not necessarily limited thereto.

In order to extract the DFG feature, the DFG extraction module 170 according to the present embodiment may include a DFG generation module 171 and a DFG inspection module 173.

First, the DFG generation module 171 according to the present embodiment may generate a DFG representing the propagation flow of actual values as nodes and edges by searching processes of storing, reading, and writing actual values of the segmented binary code.

That is, the DFG generation module 171 may search for a process of reading and writing a value to a temporary variable, a register, and a memory that store a value in a binary, based on an intermediate representation language rather than an assembly instruction. At this time, since the intermediate representation language follows a rule called static single assignment, the actual value is written and the read operation occurs consistently. Accordingly, the DFG generation module 171 may store (declare) a value in the intermediate representation language, generate a read (use) flow, and construct a DFG composed of nodes representing intermediate-representation instructions as shown in FIG. 3.

The DFG generation module 171 may transmit the generated DFG to the DFG inspection module 173.

Meanwhile, the DFG inspection module 173 according to the present embodiment may search for edges related to all values in the binary code in the generated DFG, and extract the DFG feature by modifying the edge related to the variable.

To this end, the DFG inspection module 173 according to the present embodiment may aim to filter meaningful portions of the value flow.

In order to obtain an abstracted flow of a program dependence graph (PDG) level of a source code, which will be described later, the DFG inspection module 173 may separate the step of analyzing variables within the function area, which is an analysis unit, in advance, and a portion of searching and selecting the flow of the variable within all types of data flows of a binary.

To this end, the DFG inspection module 173 may obtain a type specialized for each vulnerability by analyzing the abstracted flow together with the type of a variable in the analysis unit function region in advance.

That is, the DFG test module 173 according to the present embodiment may separate the area of the memory in which the variable is stored for each variable, identify the type of the variable, select only the type of the necessary variable according to the vulnerability type, and extract the DFG feature by maintaining only the edges for the memory corresponding to the selected variable.

Specifically, the DFG inspection module 173 may select a significant portion of all DFG edges existing for all values in the binary. To this end, the DFG inspection module may first select a DFG edge for memory locations, which is a location where variables are stored.

Thereafter, the DFG inspection module 173 may separate the memory area for each variable through the use of the memory area. In this case, the variable is a variable at the source code level, and the DFG inspection module 173 may generate the variable by backtracking how the variable's use at the source-code level is manifested, stored, and used in memory within the binary code.

In addition, the DFG inspection module 173 may check what type of data the generated variable was actually through a pattern used later.

Specifically, the DFG test module 173 derives data types such as integers, floating-point numbers, and character strings, records only necessary variable types according to the vulnerability type, and even selects DFG edges related to the selected variables.

Through the above process, the DFG inspection module 173 according to the present embodiment may separate the value flow existing in the binary into a meaningful value flow at the actual source code level and a value flow simply for the operation of the binary, which is a process for leaving meaningful information in terms of vulnerability analysis.

Accordingly, the DFG inspection module 173 may analyze and integrate the DFG edge information existing in the binary with the variable flow at the source code level to select the one including the higher-level semantic information among the countless value flows existing in the binary.

In addition, the DFG inspection module 173 may record the temporal information of the flow represented by the DFG and use it as training data that may be trained in a model later.

Accordingly, the DFG extraction module 170 including the DFG generation module 171 and the DFG inspection module 173 may extract the DFG feature by maintaining only the significant edges in the vulnerability analysis among the edges in the DFG. The DFG extraction module 170 may transmit the extracted DFG feature to the PDG synthesis module 190.

In addition, both the CFG extraction in the CFG extraction module 150 and the DFG extraction in the DFG extraction module 170 described above may be performed in parallel after the process of dividing the binary code in the binary segmentation module 130 in units of functions is performed.

Meanwhile, the PDG synthesis module 190 according to the present embodiment may decompose the CFG feature and synthesize the DFG feature with the decomposed CFG feature to generate the PDG representing the control and the data dependencies.

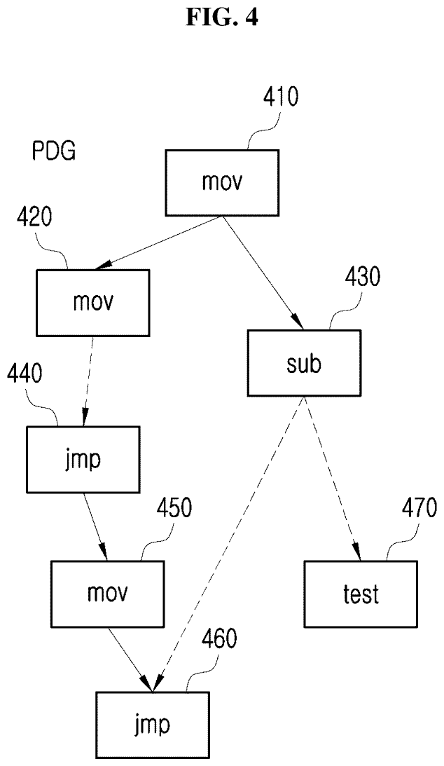

FIG. 4 is a diagram for describing a PDG generated by the PDG synthesis module 190 according to an embodiment of the present disclosure.

As shown in FIG. 2, the node of the CFG feature extracted by the CFG extraction module 150 is a basic block, and as shown in FIG. 3, the node of the DFG feature extracted by the DFG extraction module 170 is different from each other, being variables of intermediate-representation instructions.

Accordingly, the PDG synthesis module 190 may decompose the nodes of the CFG feature to integrate different nodes, and synthesize the edges of the DFG feature to the decomposed nodes to generate the PDG.

In addition, the PDG synthesis module 190 may configure nodes using raw code for ease of model learning. Here, the raw code is an assembly command or an intermediate representation instruction, and has the advantage of expressing the meaning of the operation of the binary code most simply.

FIG. 4 is a diagram exemplarily illustrating a case in which a raw code is provided as an assembly instruction, and as illustrated in FIG. 4, the PDG synthesis module 190 may synthesize edges based on CFG features (solid arrows) and edges based on DFG features (dotted arrows) based on a node composed of a single assembly instruction to generate PDG.

In addition, the PDG synthesis module 190 according to the present embodiment may be configured such that the raw code for configuring the node to synthesize the CFG feature and the DFG feature selects either assembly instructions or intermediate-representation instructions according to the user's preset and does not mix the two.

Through this, the device 100 according to the present embodiment analyzes the value flow to overcome the limitation of the binary static analysis, selectively extracts the value flow meaningful to the vulnerability analysis to generate the PDG integrated with the CFG, extracts and provides the feature information required for the vulnerability analysis model, and extracts only the feature information through the static analysis without a separate source code.

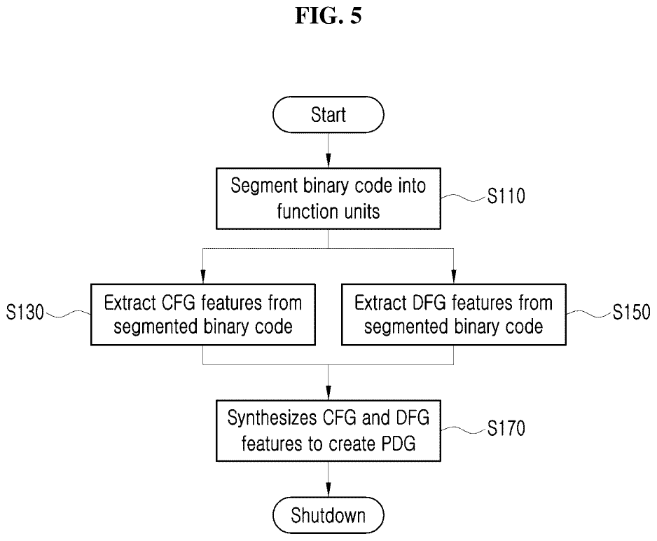

FIG. 5 is a flowchart illustrating a feature extraction method according to an embodiment of the present disclosure, and since the feature extraction method according to an embodiment of the present disclosure is performed on substantially the same configuration as the feature extraction device 100 shown in FIG. 1, the same reference numerals are assigned to the same components as the feature extraction device 100 of FIG. 1, and repeated descriptions will be omitted.

First, the device 100 may divide the received binary code into function units (S110).

The device 100 may extract a control flow graph (CFG) feature, which is a control flow in a function unit, from the segmented binary code (S130).

The extracting of the CFG feature (S130) may include generating, by the device 100, a CFG representing the control flow as nodes and edges by analyzing the control flow in a function unit from the segmented binary code.

The extracting of the CFG feature (S130) may further include extracting the CFG feature by modifying at least one of a node and an edge required for identifying a vulnerability by searching for a control flow calling an external library in the generated CFG by the device 100.

In addition, the device 100 may extract a data flow graph (DFG) feature, which is a flow of values in a function unit, from the segmented binary code in parallel with step S130 of extracting the CFG feature (S150).

The extracting of the DFG feature (S150) may include generating a DFG representing a propagation flow of actual values as nodes and edges through a search for a process of storing or reading and writing the actual value of the segmented binary code.

The extracting of the DFG feature (S150) may further include searching for edges based on all values in the binary code in the generated DFG, and extracting the DFG feature by modifying an edge related to a variable.

Thereafter, the device 100 may generate a program dependence graph (PDG) by synthesizing the CFG feature and the DFG feature (S170).

The step S170 of generating the PDG may be a step in which the device 100 decomposes the CFG feature and synthesizes the DFG feature with the decomposed CFG feature to generate a PDG representing control and data dependencies.

Specifically, the step of generating the PDG (S170) is a step of decomposing a node of the CFG feature and generating the PDG by synthesizing an edge of the DFG feature with the decomposed node, and the basic unit of the decomposed nodes may be raw code.

The feature extraction method of the present disclosure may be implemented in the form of program instructions that may be executed through various computer components and recorded in a computer-readable recording medium. The computer-readable recording medium may include program instructions, data files, data structures, and the like alone or in combination.

The program instructions recorded in the computer-readable recording medium may be specially designed and configured for the present disclosure, or may be known and used by those skilled in the field of computer software.

Examples of the computer-readable recording medium include a magnetic medium such as a hard disk, a floppy disk, and a magnetic tape, an optical recording medium such as a CD-ROM and a DVD, a magneto-optical medium such as a floptical disk, and a hardware device specially configured to store and execute program instructions such as a ROM, a RAM, a flash memory, and the like.

Examples of program instructions include not only machine language codes such as those generated by a compiler, but also high-level language codes that may be executed by a computer using an interpreter or the like. The hardware device may be configured to operate as one or more software modules to perform processing according to the present disclosure, and vice versa.

Although various embodiments of the present disclosure have been illustrated and described above, the present disclosure is not limited to the specific embodiments described above, and various modifications can be made by a person skilled in the art to which the present disclosure belongs without departing from the gist of the present disclosure claimed in the claims, and such modifications should not be individually understood from the technical spirit or the prospect of the present disclosure.

A phrase “at least one of” preceding a series of times, with the terms “and” or “or” to separate any of the times, modifies the list as a whole, rather than each member of the list. The phrase “at least one of” does not require a selection of least one item, rather, the phrase allows a meaning that includes at least one of any one of the items, and/or at least one of any combination of the items, and/or at least one of each of the items. By way of example, each of the phrases “at least one of A, B, and C” or “at least of A, B, or C” refers to Only A, only B, only C, any combination of A, B, and C, and/or at least each of A, B, and C.

What is claimed is:

1. A device for extracting a feature for identifying a vulnerability in a binary code, the device comprising:
binary segmentation circuitry configured to segment the binary code into function units;
control flow graph (CFG) extraction circuitry configured to extract a CFG feature, which is a control flow in function units, from the segmented binary code;
data flow graph (DFG) extraction circuitry configured to extract a DFG feature, which is a flow of values in function units, from the segmented binary code; and
program dependence graph (PDG) synthesis circuitry configured to decompose the CFG feature and synthesize the DFG feature with the decomposed CFG feature to generate the PDG representing control and data dependencies.

2. The device of claim 1, wherein the CFG extraction circuitry comprises:
CFG generation circuitry configured to analyze the control flow in the function units from the segmented binary code to generate a CFG representing the control flow as nodes and edges; and
CFG inspection circuitry configured to search for the control flow calling an external library in the generated CFG to extract the CFG feature by modifying at least one of a node and an edge required for identifying a vulnerability.

3. The device of claim 2, wherein the CFG inspection circuitry is further configured to:
search up to a basic block returned according to a function call corresponding to the control flow calling the external library;
delete an edge representing the control flow calling the external library according to a result of the search; and
add an edge connected to the returned basic block.

4. The device of claim 1, wherein the DFG extraction circuitry comprises:
DFG generation circuitry configured to generate a DFG representing a propagation flow of actual values as nodes and edges through a search for a process of storing, reading, or writing an actual value of the segmented binary code; and
DFG inspection circuitry configured to search for edges based on all values of the binary code in the generated DFG, and extract the DFG feature by correcting edges related to a variable.

5. The device of claim 4, wherein the DFG inspection circuitry is further configured to:
divide an area of a memory in which the variable is stored for each variable;
check a type of the variable to select types of variables corresponding to a vulnerability type; and
maintain an edge of the memory corresponding to the selected variable.

6. The device of claim 4, wherein the DFG inspection circuitry is further configured to:
generate the variable by determining the variable usage at a source-code level; and
check a type of data of the generated variable through a pattern.

7. The device of claim 1, wherein the CGF extraction circuitry extracts the CFG feature and the DFG extraction circuitry extracts the DFG feature in parallel after segmenting the binary code.

8. The device of claim 1, wherein the PDG synthesis circuitry decomposes a node of the CFG feature and synthesizes an edge of the DFG feature with the decomposed node to generate the PDG, wherein a basic unit of the decomposed node is raw code.

9. The device of claim 8, wherein the raw code is an assembly command or an intermediate representation expression.

10. The device of claim 8, wherein the raw code is an assembly instruction and wherein the PDG synthesis circuitry is further configured to:
synthesize edges based on the CFG feature and the DFG feature based on a node composed of a single assembly instruction to generate the PDG.

11. A feature extraction method in a feature extraction device for identifying a vulnerability in a binary code, the feature extraction method comprising:
dividing the binary code into function units;
extracting a control flow graph (CFG) feature, which is a control flow in function units, from the segmented binary code;
extracting a data flow graph (DFG) feature, which is a flow of values in function units, from the segmented binary code; and
decomposing the CFG feature and synthesizing the DFG feature with the decomposed CFG feature to generate a program dependence graph (PDG) representing control and data dependencies.

12. The method of claim 11, wherein the extracting of the CFG feature comprises:
analyzing the control flow in the function units from the segmented binary code to generate a CFG representing the control flow as nodes and edges; and
searching the generated CFG for the control flow calling an external library to extract the CFG feature by modifying at least one of a node and an edge required for identifying a vulnerability.

13. The method of claim 11, wherein the extracting of the DFG feature comprises:
generating a DFG representing a propagation flow of actual values as nodes and edges through a search for a process of storing or reading and writing the actual value of the segmented binary code; and
extracting the DFG feature by searching for an edge based on all values of the binary code in the generated DFG and modifying the edge related to a variable.

14. The method of claim 11, wherein the generating of the PDG comprises:
decomposing a node of the CFG feature; and
generating the PDG by synthesizing an edge of the DFG feature with the decomposed node, wherein a basic unit of the decomposed node is raw code.

15. The method of claim 14, wherein the raw code is an assembly command or an intermediate representation expression.

16. The method of claim 14, wherein the raw code is an assembly instruction and the method further comprises:
synthesizing edges based on the CFG feature and the DFG feature based on a node composed of a single assembly instruction to generate the PDG.

17. The method of claim 11, wherein the extracting of the CFG feature comprises:
searching up to a basic block returned according to a function call corresponding to the control flow calling an external library;
deleting an edge representing the control flow calling the external library according to a result of the searching; and
adding an edge connected to the returned basic block.

18. The method of claim 11, wherein the extracting of the DFG feature comprises:
dividing an area of a memory in which a variable is stored for each variable;
checking a type of the variable to select types of variables corresponding to a vulnerability type; and
maintaining an edge of the memory corresponding to the selected variable.

19. The method of claim 18, further comprising:
generating the variable by determining the variable usage at a source-code level; and
checking a type of data of the generated variable through a pattern.

20. The method of claim 11, wherein extracting the CFG feature and extracting the DFG feature are performed in parallel.
